(19) United States
(12) Patent Application Publication
(10) Pub. No.: US 2025/0186969 A1
(43) Pub. Date: Jun. 12, 2025

(54) METAL POLYMER COMPLEXES METHODS FOR CARBON DIOXIDE CAPTURE

(71) Applicant: LEHIGH UNIVERSITY, Bethlehem, PA (US)

(72) Inventors: Arup K. SENGUPTA, Bethlehem, PA (US); Hao CHEN, Bethlehem, PA (US)

(73) Assignee: LEHIGH UNIVERSITY, Bethlehem, PA (US)

(21) Appl. No.: 18/845,073

(22) PCT Filed: Mar. 6, 2023
(86) PCT No.: PCT/US2023/014575

§ 371 Date: Sep. 9, 2024

Related U.S. Application Data
(60) Provisional application No. 63/318,449, filed on Mar. 10, 2022.
(60) Provisional application No. 63/342,948, filed on May 17, 2022.

(51) Int. Cl. B01J 20/22; B01D 53/62; B01D 53/81; B01D 53/96; B01J 20/34; C01B 32/50

(52) U.S. Cl. CPC B01J 20/226; B01D 53/62; B01D 53/81; B01D 53/96; B01J 20/3425; B01J 20/3475; C01B 32/50; B01D 2253/202; B01D 2257/504; B01D 2258/06

(57) ABSTRACT

Metal polymer complexes and metal polymer complexes adapted for capturing carbon dioxide are disclosed herein. In accordance with one aspect, provided is a metal polymer complex comprising a polymer comprising at least one monomer having an amine group, the polymer complexed with a transition metal selected from nickel, zinc, copper, and a combination of two or more thereof. According to another aspect, provided is a method for capturing carbon dioxide comprising: providing an inlet gas comprising carbon dioxide and water; producing a carbonate, a bicarbonate, a salt thereof, or a combination thereof to remove carbon dioxide from the inlet gas by contacting the inlet gas with a polymer complex substrate; and removing the carbonate, the bicarbonate, the salt thereof, or the combination thereof from the polymer complex substrate by contacting the polymer complex substrate with a regenerant solution comprising water and at least one of a salt or an acid.

### CROSS-REFERENCE TO RELATED APPLICATION

This application claims the benefit of priority from U.S. Provisional Application No. 63/318,449, entitled “Direct Air Capture of CO2 at Ambient Temperature with a New Class of Tailored Chelating Exchangers” and filed Mar. 10, 2022, and from U.S. Provisional Application No. 63/342,948, entitled “Polymer-Anchored Cu(II) as a Durable High Capacity Hybrid Sorbent for Direct Air Capture (DAC) of CO2 and Sequestration” filed May 17, 2022, the contents both of which are hereby incorporated herein in their entirety.

### FIELD OF THE DISCLOSURE

Aspects of the invention are directed to methods for carbon dioxide capture. Additional aspects of the invention are directed to metal polymer complexes and, particularly, metal polymer complexes adapted for capturing carbon dioxide.

### BACKGROUND

The significant increase in CO₂ concentration in the atmosphere is held as a primary cause for global climate change. Currently, climate change is considered to be an existential threat confronting humanity, with the suffering inflicted on marginalized populations, both in the developed and in the developing world, being predicted to be disproportionately high.

The world is believed to emit approximately 35 to 40 Gt/yr of CO₂. In order to reduce CO₂ emission, countries around the world should take appropriate action to mitigate current production levels of CO₂ emission. For net-zero CO₂ emission by 2050, as recommended by United Nations Intergovernmental Panel on Climate Change or IPCC, two types of strategies are in place namely, emission reduction (e.g., replacing fossil fuels with renewable energy) and direct air capture (DAC) of CO₂ from the atmosphere.

DAC often uses an engineered sorbent that captures CO₂. The ultra-low concentration of CO₂ in the atmosphere (˜400 ppm by volume or 0.04%) is viewed as a major obstacle held responsible for low CO₂ sorption capacity of conventional engineered sorbents, mostly in the range of 0.5-1.5 mole of CO₂ per kg of sorbent.

There is an ongoing need for improvements in direct carbon capture.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

Aspects of the invention are directed to methods for carbon dioxide capture. Additional aspects of the invention are directed to metal polymer complexes and, particularly, metal polymer complexes adapted for capturing carbon dioxide.

In accordance with one aspect, provided is a metal polymer complex comprising a polymer comprising at least one monomer having an amine group, the polymer complexed with a transition metal selected from nickel, zinc, copper, and a combination of two or more thereof.

According to another aspect, a method is provided for capturing carbon dioxide. The method typically comprises providing an inlet gas comprising carbon dioxide and water; producing a carbonate, a bicarbonate, a salt thereof, or a combination thereof to remove carbon dioxide from the inlet gas by contacting the inlet gas with a polymer complex substrate; and removing the carbonate, the bicarbonate, the salt thereof, or the combination thereof from the polymer complex substrate by contacting the polymer complex substrate with a regenerant solution comprising water and at least one of a salt or an acid.

### BRIEF DESCRIPTION OF THE DRAWINGS

The features, and advantages of the invention will be apparent from the following more detailed description of certain embodiments of the invention and as illustrated in the accompanying drawings in which:

FIG. 1 is an image of a non-limiting, exemplary polymer complex substrate being loaded with copper ion in accordance with an aspect of the invention;

FIG. 2 is an image of an EDX mapping of nitrogen and copper distribution for a non-limiting exemplary polymer complex substrate according to an aspect of the invention;

FIG. 3 is a schematic of a non-limiting system in accordance with an aspect of the invention;

FIG. 4 is a graph of the carbon dioxide capacity at different relative humidity for a non-limiting exemplary polymer complex substrate according to an aspect of the invention;

FIG. 5A is a graph of CO₂ effluent histories for a bed of exemplary polymer complex substrate during five consecutive runs in accordance with an aspect of the invention;

FIG. 5B is a bar graph of the carbon dioxide capacity of a bed of exemplary polymer complex substrate for five consecutive runs according to an aspect of the invention;

FIG. 6A is a graph of the CO₂ concentration during the operation of the system depicted in FIG. 3 using either a bed of exemplary polymer complex substrate or a bed of comparative weak-base anion resin in accordance with an aspect of the invention;

FIG. 6B is a bar graph of the average CO₂ capture capacity for the bed of exemplary polymer complex or the bed of weak-base anion resin of FIG. 6A;

FIG. 7 is a bar graph of the CO₂ capacities for a bed of exemplary polymer complex or a bed of comparative weak-base anion resin at carbon dioxide concentrations of 0.04 vol. %, 10 vol. %, or 50 vol. % according to an aspect of the invention;

FIG. 8A is a graph of the carbonate elution for a bed of exemplary polymer complex using a salt solution containing 4 wt. % of NaCl in accordance with an aspect of the invention;

FIG. 8B is a graph of the carbonate elution for a bed of exemplary polymer complex using seawater according to an aspect of the invention;

FIG. 8C is a graph of the alkalinity of the spent regenerant over a period of 30 days after regeneration of a bed of exemplary polymer complex in accordance with an aspect of the invention;

FIG. 8D is a graph of the regeneration for a bed of exemplary polymer complex and a bed of comparative weak-base anion resin according to an aspect of the invention;

FIGS. 9A and 9B are graphs illustrating the amount of copper for fresh exemplary polymer complex and for exemplary polymer complex after five cycles following regeneration with Na₂SO₄ in accordance with an aspect of the invention;

FIG. 10 is a bar graphs of the copper concentration of the spent regenerant after regeneration of a bed of exemplary polymer complex according to an aspect of the invention;

FIG. 11A is a graph of the CO₂ effluent histories of a bed of exemplary polymer complex containing nickel and a bed of exemplary polymer complex containing copper in accordance with an aspect of the invention;

FIG. 11B is a bar graph of the carbon dioxide capacity of the bed of exemplary polymer complex containing nickel and the bed of exemplary polymer complex containing copper of FIG. 11A;

FIGS. 12A and 12B are graphs of the carbon dioxide capacity of a bed of exemplary polymer complex and a bed of comparative polymer complex according to an aspect of the invention;

FIG. 13 is a graph of the sorption of carbon dioxide by exemplary polymer complex under conditions of non-flowing air in accordance with an aspect of the invention;

FIGS. 14A and 14B are graphs of the sorption of a bed of exemplary polymer complex at various temperatures according to an aspect of the invention;

FIG. 14C is a graph of CO₂ effluent histories for a bed of example polymer exemplary substrate during 10 consecutive runs with the bed being regenerated using tap water at a temperature of 80° C. after each run in accordance with an aspect of the invention;

FIG. 14D is a bar graph of the carbon dioxide capacity of a bed of exemplary polymer complex after regeneration with tap water at a temperature of 80° C. according to an aspect of the invention; and

FIG. 15 is a schematic of a non-limiting, exemplary method for capturing carbon dioxide in accordance with an aspect of the invention.

It should be understood that the various aspects are not limited to the compositions, arrangements, and instrumentality shown in the figures.

### DETAILED DESCRIPTION

The features and benefits of the invention are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar terms refer to a relationship wherein structures are secured or attached to one another either directly or indirectly through intervening structures, as well as both movable or rigid attachments or relationships, unless expressly described otherwise.

As used throughout, ranges are used as shorthand for describing each and every value that is within the range. Any value within the range can be selected as the terminus of the range. Thus, a range from 1-5, includes specifically 1, 2, 3, 4 and 5, as well as subranges such as 2-5, 3-5, 2-3, 2-4, 1-4, etc.

The term “about” when referring to a number means any number within a range of 10% of the number. For example, the phrase “about 2 wt. %” refers to a number between and including 1.8 wt. % and 2.2 wt. %.

All references cited herein are hereby incorporated by reference in their entireties. In the event of a conflict in a definition in the present disclosure and that of a cited reference, the present disclosure controls.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but are not limited to”.

The abbreviations and symbols as used herein, unless indicated otherwise, take their ordinary meaning. The symbol “°” refers to a degree, such as a temperature degree or a degree of an angle. The symbols “hr”, “min”, “mL”, “nm”, and “μm” refer to hour, minute, milliliter, nanometer, and micrometer, respectively. The abbreviation “rpm” means revolutions per minute. When referring to chemical structures, and names, the symbols “C”, “H”, and “O” mean carbon, hydrogen, and oxygen, respectively.

Any member in a list of species that are used to exemplify or define a genus, may be mutually different from, or overlapping with, or a subset of, or equivalent to, or nearly the same as, or identical to, any other member of the list of species. Further, unless explicitly stated, such as when reciting a Markush group, the list of species, compounds, components, and/or elements that define or exemplify the genus is open, and it is given that other species may exist that define or exemplify the genus just as well as, or better than, any other species listed.

The phrases, “a mixture thereof,” “a combination thereof,” or a combination of two or more thereof” do not require that the mixture include all of A, B, C, D, E, and F (although all of A, B, C, D, E, and F may be included). Rather, it indicates that a mixture of any two or more of A, B, C, D, E, and F can be included. In other words, it is equivalent to the phrase “one or more elements selected from the group consisting of A, B, C, D, E, F, and a mixture of any two or more of A, B, C, D, E, and F.” Likewise, the term “a salt thereof” also relates to “salts thereof.” Thus, where the disclosure refers to “an element selected from the group consisting of A, B, C, D, E. F, a salt thereof, and a mixture thereof,” it indicates that that one or more of A, B, C, D, and F may be included, one or more of a salt of A, a salt of B, a salt of C, a salt of D, a salt of E, and a salt of F may be included, or a mixture of any two of A, B. C, D, E, F, a salt of A, a salt of B, a salt of C, a salt of D, a salt of E, and a salt of F may be included.

All components and elements positively set forth in this disclosure can be negatively excluded from the claims. In other words, the metal polymer complexes of the instant disclosure can be free or essentially free of all components, elements, and/or groups positively recited throughout the instant disclosure.

The term “hydrocarbyl” refers to any moiety or substitution on a moiety that comprises carbon and hydrogen. Hydrocarbyl units can comprise one or more heteroatoms such as oxygen, nitrogen, sulfur and the like.

Substituted and unsubstituted linear, branched, or cyclic alkyl units include the following non-limiting examples: methyl (C₁), ethyl (C₂), n-propyl (C₃), iso-propyl (C₃), cyclopropyl (C₃), n-butyl (C₄), sec-butyl (C₄), iso-butyl (C₄), tert-butyl (C₄), cyclobutyl (C₄), cyclopentyl (C₅), cyclohexyl (C), and the like; whereas substituted linear, branched, or cyclic alkyl, non-limiting examples of which includes, hydroxymethyl (C₁), chloromethyl (C₁), trifluoromethyl (C₁), aminomethyl (C₁), 1-chloroethyl (C₂), 2-hydroxyethyl (C₂), 1,2-difluoroethyl (C₂), 2,2,2-trifluoroethyl (C₃), 3-carboxypropyl (C₃), 2,3-dihydroxycyclobutyl (C₄), and the like.

The term “aryl” as used herein denotes cyclic organic units that comprise at least one benzene ring having a conjugated and aromatic six-membered ring, non-limiting examples of which include phenyl (C₆), naphthylen-1-yl (C₁₀), naphthylen-2-yl (C₁₀). Aryl rings can have one or more hydrogen atoms substituted by another organic or inorganic radical. Non-limiting examples of substituted aryl rings include: 4-fluorophenyl (C₆), 2-hydroxyphenyl (C₆), 3-methylphenyl (C₆), 2-amino-4-fluorophenyl (C₆), 2-(N,N-diethylamino)phenyl (C₆), 2-cyanophenyl (C₆), 2,6-di-tert-butylphenyl (C₆), 3-methoxyphenyl (C₆), 8-hydroxynaphthylen-2-yl (C₁₁), 4,5-dimethoxynaphthylen-1-yl (C₁₀), and 6-cyanonaphthylen-1-yl (C₁₀).

The term “heteroaryl” denotes an organic unit comprising a five or six membered conjugated and aromatic ring wherein at least one of the ring atoms is a heteroatom selected from nitrogen, oxygen, or sulfur. The heteroaryl rings can comprise a single ring, for example, a ring having 5 or 6 atoms wherein at least one ring atom is a heteroatom not limited to nitrogen, oxygen, or sulfur, such as a pyridine ring, a furan ring, or thiofuran ring. A “heteroaryl” can also be a fused multicyclic and heteroaromatic ring system having wherein at least one of the rings is an aromatic ring and at least one atom of the aromatic ring is a heteroatom including nitrogen, oxygen, or sulfur.

Aspects of the invention are directed to methods for carbon dioxide capture (CO₂). Additional aspects of the invention are directed to metal polymer complexes and, particularly, metal polymer complexes adapted for capturing carbon dioxide. The inventors discovered that certain metal polymer complexes and methods disclosed herein can advantageously achieve significantly high amounts of CO₂ sorption per amount of sorbent. For instance, certain metal polymer complexes and methods of using the same can achieve about 3 or more mole of CO₂ per kg of sorbent. In some embodiments, the metal polymer complexes and/or methods employing the same may have a sorption of about 3.5 or more, about 4 or more, about 4.5 or more, about 4.8 or more, about 5 or more, about 5.1 or more, about 5.2 or more, about 5.3 or more, about 5.4 or more, about 5.5 or more, about 5.6 or more, about 5.8 or more, or about 6 or more mole of CO₂ per kg of sorbent.

Additionally, certain embodiments can achieve the high levels of CO₂ sorption, such as one of the disclosed amounts of moles of CO₂ per kg of sorbent, from gases or gas streams having a concentration of CO₂ of about 400 ppm, such as atmospheric air. Surprisingly, the metal polymer complexes and the methods disclosed herein may be highly versatile in their application. Certain embodiments of metal polymer complexes and the methods disclosed herein may capture the carbon dioxide as a carbonate and/or bicarbonate. The carbonate and/or bicarbonate may be stably stored and/or released into an ocean, a lake, or a large water mass. Without being limited to any particularly theory, it is believed that certain embodiments disclosed herein may be adapted for reducing the acidification and/or increasing the alkalinity of an ocean, a lake, or a large water mass by disposing the carbonate and/or bicarbonate into such ocean, lake, or large water mass. In some embodiments, the method may be configured such that the production of the carbonate, the bicarbonate, the salt thereof, or the combination thereof and the removal of carbon dioxide from the inlet gas does not require the addition of external heat.

In accordance with one aspect, provided is a metal polymer complex. The metal polymer complex typically comprises a polymer comprising at least one monomer having an amine group. The polymer is generally complexed with a transition metal selected from nickel, zinc, copper, and a combination of two or more thereof. In some embodiments, the polymer is irreversibly complexed with the transition metal.

The polymer may be a vinyl polymer comprising one or more distinct monomers. For instance, the polymer may be a homopolymer, a copolymer, or a block polymer. The polymer may comprise at least one monomer with hydrocarbyl group. The hydrocarbyl group may be selected from a substituted or unsubstituted alkyl group, a substituted or unsubstituted alkenyl group, a substituted or unsubstituted phenyl group, a substituted or unsubstituted aryl group, or a substituted or unsubstituted heteroaryl group. The hydrocarbyl group—e.g., a substituted or unsubstituted alkyl group, a substituted or unsubstituted alkenyl group, a substituted or unsubstituted phenyl group, a substituted or unsubstituted aryl group, or a substituted or unsubstituted heteroaryl group—may be linear, branched, or cyclic. The polymer may be a bis-picolylamine polymer, crosslinked styrene-based polymer (e.g., macroporous polystyrene crosslinked with divinylbenzene), and/or an acrylate-based copolymer. For example, the bis-picolylamine may be formed from at least one vinyl monomer. Example of bis-picolylamine polymers that may be useful can be found in U.S. Pat. No. 8,562,922, which is incorporated herein by reference in its entirety for all purposes. Examples of crosslinked styrene-based polymers that may be useful can be found in U.S. Patent Publication No. 2010/247415, U.S. Patent Publication No. 2008/0169241, and U.S. Patent Publication No. 2020/354237, which are each incorporated herein by reference in their entirety for all purposes.

The molecular weight of the polymer may be about 10,000 g/mol or more. For example, the polymer may have a molecular weight of about 30,000 g/mol or more, about 50,000 g/mol or more, about 80,000 g/mol or more, about 110,000 g/mol or more, about 140,000 g/mol or more, about 170,000 g/mol or more, about 200,000 g/mol or more, about 250,000 g/mol or more, about 300,000 g/mol or more, about 350,000 g/mol or more, about 400,000 g/mol or more, about 450,000 g/mol or more, about 500,000 g/mol or more, about 600,000 g/mol or more, about 700,000 g/mol or more, about 800,000 g/mol or more, about 900,000 g/mol or more, about 1,000,000 g/mol or more, about 1,200,000 g/mol or more, or about 1,400,000 g/mol or more. Additionally or alternatively, the molecular weight of the polymer may be from about 10,000 g/mol to about 1,400,000 g/mol. In some instance, the molecular weight of the polymer is from about 10,000 g/mol to about 1,400,000 g/mol, about 10,000 g/mol to about 1,000,000 g/mol, about 10,000 g/mol to about 800,000 g/mol, about 10,000 g/mol to about 600,000 g/mol, about 10,000 g/mol to about 400,000 g/mol, about 10,000 g/mol to about 200,000 g/mol, about 10,000 g/mol to about 100,000 g/mol, about 10,000 g/mol to about 80,000 g/mol, about 10,000 g/mol to about 60,000 g/mol; from about 30,000 g/mol to about 1,400,000 g/mol, about 30,000 g/mol to about 1,000,000 g/mol, about 30,000 g/mol to about 800,000 g/mol, about 30,000 g/mol to about 600,000 g/mol, about 30,000 g/mol to about 400,000 g/mol, about 30,000 g/mol to about 200,000 g/mol, about 30,000 g/mol to about 100,000 g/mol, about 30,000 g/mol to about 80,000 g/mol, about 30,000 g/mol to about 60,000 g/mol; from about 50,000 g/mol to about 1,400,000 g/mol, about 50,000 g/mol to about 1,000,000 g/mol, about 50,000 g/mol to about 800,000 g/mol, about 50,000 g/mol to about 600,000 g/mol, about 50,000 g/mol to about 400,000 g/mol, about 50,000 g/mol to about 200,000 g/mol, about 50,000 g/mol to about 100,000 g/mol, about 50,000 g/mol to about 80,000 g/mol; from about 100,000 g/mol to about 1,400,000 g/mol, about 100,000 g/mol to about 1,000,000 g/mol, about 100,000 g/mol to about 800,000 g/mol, about 100,000 g/mol to about 600,000 g/mol, about 100,000 g/mol to about 400,000 g/mol, about 100,000 g/mol to about 200,000 g/mol; from about 200,000 g/mol to about 1,400,000 g/mol, about 200,000 g/mol to about 1,000,000 g/mol, about 200,000 g/mol to about 800,000 g/mol, about 200,000 g/mol to about 600,000 g/mol, about 200,000 g/mol to about 400,000 g/mol; from about 300,000 g/mol to about 1,400,000 g/mol, about 300,000 g/mol to about 1,000,000 g/mol, about 300,000 g/mol to about 800,000 g/mol, about 300,000 g/mol to about 600,000 g/mol, about 300,000 g/mol to about 400,000 g/mol; from about 500,000 g/mol to about 1,400,000 g/mol, about 500,000 g/mol to about 1,000,000 g/mol, about 500,000 g/mol to about 800,000 g/mol; from about 700,000 g/mol to about 1,400,000 g/mol, about 700,000 g/mol to about 1,000,000 g/mol; from about 900,000 g/mol to about 1,400,000 g/mol, about 900,000 g/mol to about 1,000,000 g/mol, or any range or subrange thereof.

Preferably, the hydrocarbyl group comprises 1 to 30 carbons. For example, the hydrocarbyl group may be selected from a C₁₋₃₀ substituted or unsubstituted alkyl group, a C₁₋₃₀ substituted or unsubstituted alkenyl group, a C₁₋₃₀ substituted or unsubstituted phenyl group, a C₁₋₃₀ substituted or unsubstituted aryl group, or a C₁₋₃₀ substituted or unsubstituted heteroaryl group. In some embodiments, the hydrocarbyl group may comprise 2 to 30 carbons, 4 to 30 carbons, 8 to 30 carbons, 12 to 30 carbons, 16 to 30 carbons, 20 to 30 carbons, 24 to 30 carbons; from 1 to 20 carbons, 2 to 20 carbons, 3 to 20 carbons, 4 to 20 carbons, 5 to 20 carbons, 6 to 20 carbons, 7 to 20 carbons, 8 to 20 carbons, 10 to 20 carbons, 12 to 20 carbons; from 2 to 17 carbons, 3 to 17 carbons, 4 to 17 carbons, 5 to 17 carbons, 6 to 17 carbons, 7 to 17 carbons, 8 to 17 carbons, 10 to 17 carbons, 12 to 17 carbons; from 2 to 14 carbons, 3 to 14 carbons, 4 to 14 carbons, 5 to 14 carbons, 6 to 14 carbons, 7 to 14 carbons, 8 to 14 carbons, 10 to 14 carbons; from 2 to 11 carbons, 3 to 11 carbons, 4 to 11 carbons, 5 to 11 carbons, 6 to 11 carbons, 7 to 11 carbons, 8 to 11 carbons; from 2 to 9 carbons, 3 to 9 carbons, 4 to 9 carbons, 5 to 9 carbons, 6 to 9 carbons, 7 to 9 carbons, or any range or subrange thereof.

The polymer typically comprises at least one monomer having an amine group, which may be a primary, second, or tertiary amine. Preferably, the amine group is a primary amine. The amine group may be part of or a substituent of the hydrocarbyl group. For example, the amine may be a substituent of a phenyl group of one of the monomers comprising the polymer. In at least one embodiment, the polymer is a vinyl polymer comprising a phenyl group having an amine, preferably a primary amine. In some embodiments, the polymer comprises bis-polyamine, e.g., a bis-picolylamine polymer resin.

The polymer is typically complexed with a transition metal selected from nickel, zinc, copper, cobalt, and a combination of two or more thereof. In some cases, the transition metal comprises nickel, copper, cobalt, or a combination thereof. Preferably, the metal polymer complex comprises a copper ion. In at least one embodiment, the metal polymer complex comprises Cu(II).

The polymer may be complexed with two or more transition metals, with one of the transition metals being selected from nickel, zinc, copper, and a combination of two or more thereof. The polymer may be complexed with one or more additional transition metals selected from copper, cobalt, nickel, zinc, or a combination thereof. For example, metal polymer complex may comprise two transition metals, with one of the transition metals being selected from Cu(II), Co(II), Ni(II), and Zn(II).

The metal polymer complex may be adapted to have a nitrogen to copper ratio of about 1.5 to about 4.5. For example, the metal polymer complex may have a nitrogen to copper ratio from about 1.5 to about 4.5, about 1.5 to about 4, about 1.5 to about 3.5, about 1.5 to about 3.25, about 1.5 to about 3; from about 2 to about 4.5, about 2 to about 4, about 2 to about 3.5, about 2 to about 3.25, about 2 to about 3; from about 2.5 to about 4.5, about 2.5 to about 4, about 2.5 to about 3.5, about 2.5 to about 3.25, about 2.5 to about 3; from about 2.75 to about 4.5, about 2.75 to about 4, about 2.75 to about 3.5, about 2.75 to about 3.25, about 2.75 to about 3, or any range or subrange thereof. In at least one embodiment, the nitrogen to copper ratio of the metal polymer complex is 3 or about 3.

Additionally or alternatively, the metal polymer complex may be adapted to have a nitrogen to nickel ratio of about 1.5 to about 4.5. For example, the metal polymer complex may have a nitrogen to nickel ratio from about 1.5 to about 4.5, about 1.5 to about 4, about 1.5 to about 3.5, about 1.5 to about 3.25, about 1.5 to about 3; from about 2 to about 4.5, about 2 to about 4, about 2 to about 3.5, about 2 to about 3.25, about 2 to about 3; from about 2.5 to about 4.5, about 2.5 to about 4, about 2.5 to about 3.5, about 2.5 to about 3.25, about 2.5 to about 3; from about 2.75 to about 4.5, about 2.75 to about 4, about 2.75 to about 3.5, about 2.75 to about 3.25, about 2.75 to about 3, or any range or subrange thereof.

Additionally or alternatively, the metal polymer complex may be adapted to have a nitrogen to zinc ratio of about 1.5 to about 4.5. For example, the metal polymer complex may have a nitrogen to zinc ratio from about 1.5 to about 4.5, about 1.5 to about 4, about 1.5 to about 3.5, about 1.5 to about 3.25, about 1.5 to about 3; from about 2 to about 4.5, about 2 to about 4, about 2 to about 3.5, about 2 to about 3.25, about 2 to about 3; from about 2.5 to about 4.5, about 2.5 to about 4, about 2.5 to about 3.5, about 2.5 to about 3.25, about 2.5 to about 3; from about 2.75 to about 4.5, about 2.75 to about 4, about 2.75 to about 3.5, about 2.75 to about 3.25, about 2.75 to about 3, or any range or subrange thereof.

Additionally or alternatively, the metal polymer complex may be adapted to have a nitrogen to cobalt ratio of about 1.5 to about 4.5. For example, the metal polymer complex may have a nitrogen to cobalt ratio from about 1.5 to about 4.5, about 1.5 to about 4, about 1.5 to about 3.5, about 1.5 to about 3.25, about 1.5 to about 3; from about 2 to about 4.5, about 2 to about 4, about 2 to about 3.5, about 2 to about 3.25, about 2 to about 3; from about 2.5 to about 4.5, about 2.5 to about 4, about 2.5 to about 3.5, about 2.5 to about 3.25, about 2.5 to about 3; from about 2.75 to about 4.5, about 2.75 to about 4, about 2.75 to about 3.5, about 2.75 to about 3.25, about 2.75 to about 3, or any range or subrange thereof.

The metal polymer complex may be adapted to have a positive charge. For instance, the metal polymer complex may have a positive charge of 2 or more. In some embodiments, the metal polymer complex is adapted to have a positive charge of 2, 3, or 4. The transition metal of the metal polymer complex may be selected from Ni(II), Co(II), Zn(II), Cu(II), or a combination of two or more thereof.

The metal polymer complex may be in the form of substrate and/or have the shape of a bead, a pellet, a particle, a strip, a string, or the like. The metal polymer complex may, in some instances, have an irregular shape and/or have any of the foregoing shapes with irregularities. Additionally or alternatively, the metal polymer complex may adapted for attachment or coupling to a substrate, such as wiring, a mesh, a seize, a surface, or the like.

In accordance with certain aspects of the invention, provided is a metal polymer complex comprising an anion exchange resin, wherein the anion exchange resin has been loaded with a transition metal selected from: nickel, zinc, copper, cobalt and a combination of two or more. The anionic exchange resin may be formed at least partially from certain polymers described above. For example, the anionic exchange resin may be formed from one of the polymers described above having at least one monomer with hydrocarbyl group, such as those selected from a substituted or unsubstituted alkyl group, a substituted or unsubstituted alkenyl group, a substituted or unsubstituted phenyl group, a substituted or unsubstituted aryl group, or a substituted or unsubstituted heteroaryl group. The polymer may have any of the molecular weights described above, including, e.g., those from about 10,000 g/mol to about 1,400,000 g/mol.

The anionic exchange resin of the metal polymer complex may comprise or be formed of a polymer having a hydrocarbyl group that is branched, linear, or cylic, and comprising 1 to 30 carbons, such as any of the ranges discussed above. For example, the hydrocarbyl group may be selected from a C₁₋₃₀ substituted or unsubstituted alkyl group, a C₁₋₃₀ substituted or unsubstituted alkenyl group, a C₁₋₃₀ substituted or unsubstituted phenyl group, a C₁₋₃₀ substituted or unsubstituted aryl group, or a C₁₋₃₀ substituted or unsubstituted heteroaryl group.

In some preferred embodiments, the metal polymer complex and/or anion exchange resin has a polymer complexed with a transition metal using an ionic compound formed of, e.g., the transition metal and a halogen and/o a non-metal, such as an oxygen. In at least one embodiment, the metal polymer complex and/or anion exchange resin may be complexed with copper ions using copper chloride and/or copper sulfate. In some embodiments, the metal polymer complex and/or anion exchange resin may be loaded with the transition metal using, e.g., an ionic compound that may, in some instances, be similar or the same as those used for complexing the polymer and the transition metal.

The metal polymer complex may comprise an anion exchange resin containing a gel phase, which commonly refers to the interior of an ionically charged polymer. The metal polymer complex and/or anion exchange resin may be macroporous. In some cases, the pores, voids, or reticules of the metal polymer complex and/or anion exchange resin are within or substantially within the range of about 200 □ to about 2,000 □.

The anion exchange resin may be strong base anion exchange resin or weak base anion exchange resin. The resin matrix of weak base anion-exchange resins may contain chemically bonded thereto a basic, nonionic functional group. The functional groups may be include primary, secondary, or tertiary amine groups. These may be aliphatic, aromatic, heterocyclic or cycloalkane amine groups. The amines can be selected from alpha, alpha-dipyridyl, guanidine, dicyanodiamidine groups, and combinations thereof. Other nitrogen-containing basic, non-ionic functional groups include nitrite, cyanate, isocyanate, thiocyanate, isothiocyanate, and isocyanide groups. Pyridine groups may also be employed. Strong base anion exchange resins may be formed of polymers having mobile anions, such as hydroxide and the like, associated for example with covalently bonded quaternary ammonium, phosphonium or arsonium functional groups or tertiary sulfonium functional groups.

In accordance with another aspect, provided is a method for producing a metal polymer complex by complexing a polymer comprising at least one monomer having an amine group with a transition metal selected from nickel, zinc, copper, and a combination of two or more thereof.

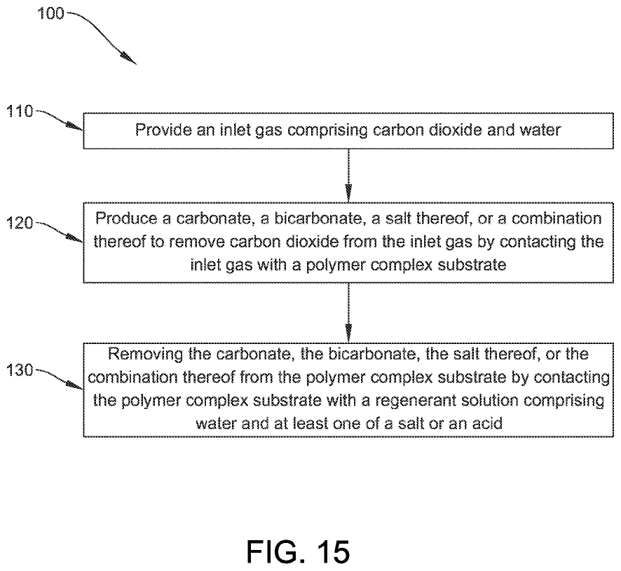

According to a further aspect, provided is a method for capturing carbon dioxide. A method 100 for capturing carbon dioxide according to an aspect of the invention is depicted in FIG. 15. As a brief overview, method 100 typically comprises providing an inlet gas comprising carbon dioxide and water in step 110; producing a carbonate, a bicarbonate, a salt thereof, or a combination thereof to remove carbon dioxide from the inlet gas by contacting the inlet gas with a polymer complex substrate in step 120; and removing the carbonate, the bicarbonate, the salt thereof, or the combination thereof from the polymer complex substrate by contacting the polymer complex substrate with a regenerant solution comprising water and at least one of a salt or an acid in step 130.

In step 110, an inlet gas is typically provided comprising carbon dioxide and water. The inlet gas comprising carbon dioxide may be part of or form a continuous stream. In some instances, the inlet gas is obtained from an outlet stream from a source point, such as a manufacturer, a chemical plant, an energy plant, a combustion engine, or the like. Alternatively or additionally, the inlet gas may comprise atmospheric air. The inlet gas may comprise a concentration of carbon dioxide of about 350 ppm or more. For instance, the carbon dioxide concentration of the inlet gas may be from about 0.04 to about 50 mol %, about 0.04 to about 35 mol %, about 0.04 to about 25 mol %, about 0.04 to about 20 mol %, about 0.04 to about 17 mol %, about 0.04 to about 14 mol %, about 0.04 to about 12 mol %, about 0.04 to about 10 mol %, about 0.04 to about 8 mol %, about 0.04 to about 6 mol %, about 0.04 to about 5 mol %, about 0.04 to about 4 mol %, about 0.04 to about 3 mol %, about 0.04 to about 2 mol %, about 0.04 to about 1 mol %, about 0.04 to about 0.5 mol %; from about 1 to about 50 mol %, about 1 to about 35 mol %, about 1 to about 25 mol %, about 1 to about 20 mol %, about 1 to about 17 mol %, about 1 to about 14 mol %, about 1 to about 12 mol %, about 1 to about 10 mol %, about 1 to about 8 mol %, about 1 to about 6 mol %, about 1 to about 5 mol %, about 1 to about 4 mol %, about 1 to about 3 mol %; from about 2 to about 50 mol %, about 2 to about 35 mol %, about 2 to about 25 mol %, about 2 to about 20 mol %, about 2 to about 17 mol %, about 2 to about 14 mol %, about 2 to about 12 mol %, about 2 to about 10 mol %, about 2 to about 8 mol %, about 2 to about 6 mol %, about 2 to about 5 mol %; from about 4 to about 50 mol %, about 4 to about 35 mol %, about 4 to about 25 mol %, about 4 to about 20 mol %, about 4 to about 17 mol %, about 4 to about 14 mol %, about 4 to about 12 mol %, about 4 to about 10 mol %; from about 8 to about 50 mol %, about 8 to about 35 mol %, about 8 to about 25 mol %, about 8 to about 20 mol %, about 8 to about 17 mol %, about 8 to about 14 mol %, about 8 to about 12 mol %; from about 10 to about 50 mol %, about 10 to about 35 mol %, about 10 to about 25 mol %, about 10 to about 20 mol %, about 10 to about 17 mol %, about 10 to about 14 mol %, about 10 to about 12 mol %; from about 12 to about 50 mol %, about 12 to about 35 mol %, about 12 to about 25 mol %, about 12 to about 20 mol %, about 12 to about 17 mol %, about 12 to about 14 mol %; from about 14 to about 50 mol %, about 14 to about 35 mol %, about 14 to about 25 mol %, about 14 to about 20 mol %, about 14 to about 17 mol %; from about 16 to about 50 mol %, about 16 to about 35 mol %, about 16 to about 25 mol %, about 16 to about 20 mol %; from about 18 to about 50 mol %, about 18 to about 35 mol %, about 18 to about 25 mol %, about 18 to about 20 mol %; from about 20 to about 50 mol %, about 20 to about 35 mol %, about 20 to about 25 mol %; from about 25 to about 50 mol %, about 25 to about 35 mol %, about 25 to about 30 mol %; from about 30 to about 50 mol %, about 30 to about 35 mol %; from about 35 to about 50 mol %, about 35 to about 40 mol %, about 40 to about 50 mol %, or any range or subrange thereof, based on the total composition of the inlet gas. In some embodiments, the method is adapted for an inlet gas having a concentration of carbon dioxide of about 10 to about 14 mol %, based on the total composition of the inlet gas. In further embodiments, the method is adapted for an inlet gas having a concentration of carbon dioxide of about 16 to about 25 mol %, based on the total composition of the inlet gas.

The inlet gas preferably includes water, although the inlet gas may be free of water. The method may include adding water to the inlet gas to increase the relative humidity of the inlet gas. Water may be added to the inlet gas, e.g., by spraying or misting water into the inlet gas. The inlet gas may have or be adjusted to have a relative humidity of about 10% or more when the inlet gas is at a temperature of 25° C. Preferably, the relative humidity of the inlet gas is about 20% or more at a temperature of 25° C. In some embodiments, the inlet gas is adjusted to have a relative humidity of about 10 to about 90% relative humidity at a temperature of 25° C. For example, relative humidity of the inlet gas may be adjusted to about 10 to about 90%, about 20 to about 90%, about 30 to about 90%, about 40 to about 90%, about 45 to about 90%, about 50 to about 90%, about 55 to about 90%, about 60 to about 80%, about 65 to about 90%, about 70 to about 90%; about 10 to about 80%, about 20 to about 80%, about 30 to about 80%, about 40 to about 80%, about 45 to about 80%, about 50 to about 80%, about 55 to about 80%, about 60 to about 80%, about 65 to about 80%, about 70 to about 80%; from about 10 to about 70%, about 20 to about 70%, about 30 to about 70%, about 40 to about 70%, about 45 to about 70%, about 50 to about 70%, about 55 to about 70%, about 60 to about 70%; from about 10 to about 60%, about 20 to about 60%, about 30 to about 60%, about 40 to about 60%, about 45 to about 60%, about 50 to about 60%; from about 10 to about 50%, about 20 to about 50%, about 30 to about 50%, about 40 to about 50%; from about 10 to about 40%, about 20 to about 40%, about 30 to about 40%, or any range or subrange thereof, when the inlet gas is at a temperature of 25° C. The relative humidity may be adjusted by adding moisture or removing moisture, e.g., by introducing dry air, heating the inlet gas, or the like.

Additionally or alternatively, the inlet gas may have a temperature of about 76° C. or less. For example, the inlet gas may have a temperature of about 60° C. or less, about 55° C. or less, about 50° C. or less, about 48° C. or less, about 46° C. or less, about 44° C. or less, about 42° C. or less, about 40° C. or less, about 38° C. or less, about 32° C. or less, about 28° C. or less, about 24° C. or less, about 20° C. or less, about 16° C. or less, or about 12° C. or less. In some embodiments, the inlet gas may have a temperature of from about −10 to about 60° C., about −5 to about 60° C., about 0 to about 60° C., about 5 to about 60° C., about 10 to about 60° C., about 20 to about 60° C., about 30 to about 60° C., about 35 to about 60° C.; from about −10 to about 55° C., about −5 to about 55° C., about 0 to about 55° C., about 5 to about 55° C., about 10 to about 55° C., about 20 to about 55° C., about 30 to about 55° C., about 35 to about 55° C.; from about −10 to about 50° C., about −5 to about 50° C., about 0 to about 50° C., about 5 to about 50° C., about 10 to about 50° C., about 20 to about 50° C., about 30 to about 50° C., about 35 to about 50° C.; from about −10 to about 45° C., about −5 to about 45° C., about 0 to about 45° C., about 5 to about 45° C., about 10 to about 45° C., about 20 to about 45° C., about 30 to about 45° C., about 35 to about 45° C.; from about −10 to about 42° C., about −5 to about 42° C., about 0 to about 42° C., about 5 to about 42° C., about 10 to about 42° C., about 20 to about 42° C., about 30 to about 42° C., about 35 to about 42° C.; from about −10 to about 39° C., about −5 to about 39° C., about 0 to about 39° C., about 5 to about 39° C., about 10 to about 39° C., about 20 to about 39° C., about 30 to about 39° C.; from about −10 to about 36° C., about −5 to about 36° C., about 0 to about 36° C., about 5 to about 36° C., about 10 to about 36° C., about 20 to about 36° C., about 30 to about 36° C.; from about −10 to about 33° C., about −5 to about 33° C., about 0 to about 33° C., about 5 to about 33° C., about 10 to about 33° C., about 20 to about 33° C.; from about −10 to about 30° C., about −5 to about 30° C., about 0 to about 30° C., about 5 to about 30° C., about 10 to about 30° C., about 20 to about 30° C., or any range or subrange thereof.

In step 120, a carbonate, a bicarbonate, a salt thereof, or a combination thereof is typically produced to remove carbon dioxide from the inlet gas by contacting the inlet gas with a polymer complex substrate. The polymer complex substrate may comprise a metal polymer complex, such as any of the metal polymer complexes described herein. For instance, the polymer complex substrate may comprise metal polymer complex includes a polymer having at least one monomer having a primary amine group, wherein the polymer is complexed with a copper ion, a nickel ion, or a combination thereof.

The polymer complex substrate may be adapted to bond to and/or uptake weak acid forms of carbon dioxide, such as carbonic acid and H₂CO₃. Without being limited to any particular theory, it is believed that the polymer complex substrate comprising certain embodiments of the metal polymer complex can achieve uptake of carbon dioxide from the atmosphere in the following sequence: i) dissolution of carbon dioxide in the moisture/humidity in the vicinity of Cu²⁺ at the sorbent interface; ii) transport of non-ionized H₂CO₃ inside the metal polymer complex, and iii) rapid neutralization with OH⁻ followed by selective binding of CO₃²⁻. Below is the believed reaction scheme for certain metal polymer complexes bonding to and/or uptaking carbon dioxide:

CO₂(g)+H₂O→H₂CO₃P̅o̅l̅y̅m̅e̅r̅−̅N̅−̅C̅u̅²̅⁺̅(̅O̅H̅⁻̅)̅₂̅+H₂CO₃→P̅o̅l̅y̅m̅e̅r̅−̅N̅−̅C̅u̅²̅⁺̅(̅C̅O̅₃̅²̅⁻̅)̅+2H₂O

In some embodiments, the production of the carbonate, the bicarbonate, the salt thereof, or the combination thereof and the removal of carbon dioxide from the inlet gas does not require the addition of external heat.

In step 130, the carbonate, the bicarbonate, the salt thereof, or the combination thereof is removed from the polymer complex substrate by contacting the polymer complex substrate with a regenerant solution comprising water and at least one of a salt or an acid. Although removal of the carbonate, the bicarbonate, the salt thereof, or the combination thereof from the polymer complex substrate is preferably performed without the addition of external heat, in some embodiments external heat may be employed to remove the carbonate, the bicarbonate, the salt thereof, or the combination thereof from the polymer complex substrate.

Without being limited to any particular theory, it is believed that for certain embodiments the removal of the carbonate, the bicarbonate, the salt thereof, or the combination thereof from the polymer complex substrate may occur according to the following reaction scheme:

P̅o̅l̅y̅m̅e̅r̅−̅N̅−̅C̅u̅²̅⁺̅(̅C̅O̅₃̅²̅⁻̅)̅+NaCl→P̅o̅l̅y̅m̅e̅r̅−̅N̅−̅C̅u̅²̅⁺̅(̅C̅l̅)̅₂̅+Na₂CO₃Na₂CO₃+H₂O→2Na⁺+HCO₃⁻+OH⁻

In some embodiments, the desorption of the captured carbon dioxide in various forms, such as NaCO₃ and simultaneous sequestration into an aqueous outlet solution may occur in a single step.

The method may include employing heat and water for regeneration of the polymer complex substrate. For instance, the method may use steam and/or hot water as a regenerate for regeneration of the polymer complex substrate. The hot water may have a temperature of about 50° C. or more, about 70° C. or more, about 80° C. or more, about 90° C. or more, or about 95° C. or more, or about 100° C. Additionally or alternatively, the method may utilize hot water for regenerating the polymer complex substrate having a temperature of about 50 to about 100° C., about 60 to about 100° C., about 70 to about 100° C., about 80 to about 100° C., about 90 to about 100° C., or any range or subrange thereof. The method may employ steam preferably having a temperature that is less than the melting and/or deformation temperature of the polymer complex substrate. The temperature of the steam may, in some cases, be from about 100° C. to about 300° C., about 100° C. to about 270° C., about 100° C. to about 240° C., about 100° C. to about 210° C., about 100° C. to about 190° C., about 100° C. to about 180° C., about 100° C. to about 170° C., about 100° C. to about 160° C., about 100° C. to about 150° C., about 100° C. to about 130° C.; from about 110° C. to about 300° C., about 110° C. to about 270° C., about 110° C. to about 240° C., about 110° C. to about 210° C., about 110° C. to about 190° C., about 110° C. to about 180° C., about 110° C. to about 170° C., about 110° C. to about 160° C., about 110° C. to about 150° C., about 110° C. to about 130° C.; from about 130° C. to about 300° C., about 130° C. to about 270° C., about 130° C. to about 240° C., about 130° C. to about 210° C., about 130° C. to about 190° C., about 130° C. to about 180° C., about 130° C. to about 170° C., about 130° C. to about 160° C., about 130° C. to about 150° C.; from about 150° C. to about 300° C., about 150° C. to about 270° C., about 150° C. to about 240° C., about 150° C. to about 210° C., about 150° C. to about 190° C., about 150° C. to about 180° C., about 150° C. to about 170° C.; from about 170° C. to about 300° C., about 170° C. to about 270° C., about 170° C. to about 240° C., about 170° C. to about 210° C., or any range or subrange thereof.

Method 100 may also include converting the metal polymer complex from a chloride containing form to a hydroxyl containing form. For instance, the metal polymer complex may be contacted with a strong base to convert the metal polymer complex from a chloride containing form to hydroxyl containing form. The strong base may be a caustic material containing hydroxyl groups. For instance, the strong base may be sodium hydroxide, potassium hydroxide, rubidium hydroxide, calcium hydroxide, strontium hydroxide, barium hydroxide, lithium hydroxide, or combinations thereof. In at least one embodiment, the method includes employing sodium hydroxide during the step of regenerating the metal polymer complex. Without being particularly limited to any theory, it is believed that the metal polymer complex in a chloride containing form may be converted to a hydroxyl containing form using sodium hydroxide according to the following reaction scheme:

P̅o̅l̅y̅m̅e̅r̅−̅N̅−̅C̅u̅²̅⁺̅(̅C̅l̅)̅₂̅+2OH⁻→P̅o̅l̅y̅m̅e̅r̅−̅N̅−̅C̅u̅²̅⁺̅(̅O̅H̅⁻̅)̅₂̅+2Cl⁻

The regenerant solution typically comprises water and at least one of a salt or an acid. The acid may be selected from strong Lewis acids, such as hydrochloric acid, nitric acid, sulfuric acid, hydrobromic acid, perchloric acid, or a combination of two or more thereof. In some embodiments, the regenerant solution comprises water and is free of an acid. The salt may comprise from sodium chloride, sodium nitrate, sodium sulfate, sodium lactate, potassium chloride, potassium sulfate, potassium nitrate, potassium lactate, or any combination of two or more thereof. In some embodiments, the regenerant solution comprises seawater, which contains sodium chlorides. The seawater may be filtered before use as the regenerant solution.

The regenerant solution containing the carbonate, the bicarbonate, the salt thereof, or the combination thereof (also referred to herein as “spent regenerant solution”) from the polymer complex substrate typically has an alkalinity that is higher than the regenerant solution prior to removing the carbonate, the bicarbonate, the salt thereof, or the combination thereof from the polymer complex substrate and/or metal polymer complex. In some embodiments, the spent regenerant solution has an alkalinity that is greater than the alkalinity of the regenerant solution by about 30% or more, about 50% or more, about 70% or more, about 100% or more, about 130% or more, about 170% or more, about 210% or more, about 250% or more, about 300% or more, about 350% or more, about 400% or more, about 470% or more, about 540% or more, about 610% or more, or about 780% or more. For instance, the spent regenerant solution has an alkalinity that is greater than the alkalinity of the regenerant solution by about 30 to about 610%, about 30 to about 500%, about 30 to about 400%, about 30 to about 350%, about 30 to about 300%, about 30 to about 250%, about 30 to about 200%, about 30 to about 150%, about 30 to about 100%; from about 70 to about 610%, about 70 to about 500%, about 70 to about 400%, about 70 to about 350%, about 70 to about 300%, about 70 to about 250%, about 70 to about 200%, about 70 to about 150%; from about 110 to about 610%, about 110 to about 500%, about 110 to about 400%, about 110 to about 350%, about 110 to about 300%, about 110 to about 250%, about 110 to about 200%, about 110 to about 150%; from about 150 to about 610%, about 150 to about 500%, about 150 to about 400%, about 150 to about 350%, about 150 to about 300%, about 150 to about 250%, about 150 to about 200%; from about 190 to about 610%, about 190 to about 500%, about 190 to about 400%, about 190 to about 350%, about 190 to about 300%, about 190 to about 250%; from about 240 to about 610%, about 240 to about 500%, about 240 to about 400%, about 240 to about 350%, about 240 to about 300%; from about 290 to about 610%, about 290 to about 500%, about 290 to about 400%, about 290 to about 350%; from about 340 to about 610%, about 340 to about 500%, about 340 to about 400%; from about 390 to about 610%, about 390 to about 500%, or any range or subrange thereof. In some embodiments, the carbonate, the bicarbonate, the salt thereof, or the combination thereof is removed from the polymer complex substrate using the regenerant solution without the addition of external heat.

The spent regenerant solution may comprise CaCO₃ in a concentration about 500 to about 1000 mg/L. For instance, the method may be adapted to yield a spent regenerant solution having CaCO₃ in a concentration from about 500 to about 1000 mg/L, about 500 to about 900 mg/L, about 500 to about 800 mg/L, about 500 to about 700 mg/L, about 500 to about 600 mg/L; from about 600 to about 1000 mg/L, about 600 to about 900 mg/L, about 600 to about 800 mg/L, about 600 to about 700 mg/L; from about 700 to about 1000 mg/L, about 700 to about 900 mg/L, about 700 to about 800 mg/L; from about 800 to about 1000 mg/L, about 800 to about 900 mg/L, about 900 to about 1000 mg/L, or any range or subrange thereof.

Method 100 may include disposing the spent regenerant solution into a water mass, such as a lake, a river, or an ocean. The spent regenerant solution may be adapted to reduce the acidification of a lake, a river, and/or an ocean. For instance, certain methods disclosed herein may produce a spent regenerant solution that has an alkalinity higher than that of a lake, a river, and/or an ocean. In at least one embodiment, the regenerant solution comprises seawater/ocean water and the spent regenerant solution has an alkalinity that is higher than the seawater/ocean, such that the spent regenerant solution is adapted to reduce the acidification of ocean.

In some embodiments, method 100 may include recovering carbon dioxide from the regenerant solution by contacting the regenerant solution with a weak-acid cation exchanger. For instance, a pure gaseous carbon dioxide can be recovered from the spent regenerant, with high alkalinity, by passing the spent regenerant through a weak-acid cation (WAC) exchanger to recover pure carbon dioxide. Without being limited to any particular theory, in some embodiments, the recovery of the carbon dioxide from the spent regenerant occurs according to the following reaction scheme:

Na⁺+HCO₃⁻+R̅−̅C̅O̅O̅⁻̅H̅⁺̅→R̅C̅O̅O̅⁻̅N̅a̅⁺̅+H₂O+CO₂↑

The weak-acid cation exchanger may be selected from polyacrylic macroporous/porous weak-acid cation exchangers having carboxylic acid functional groups, polymethacrylic macroporous/porous weak-acid cation exchangers having carboxylic acid functional groups, shallow shell polyacrylic macroporous/porous weak-acid cation exchangers in hydrogen form having carboxylic acid functional groups, and combinations of two or more thereof.

### EXAMPLES

The following examples are described primarily for further elucidating the advantages achieved by certain aspects and embodiments of the invention.

### Example 1

A non-limiting, example metal polymer complex substrate (Example Cu Polymer Complex) configured for capturing carbon dioxide was prepared in accordance with aspects of the invention. The Example Cu Polymer Complex was prepared from a weak-base anion resin comprising a polymer according to the following general structure:

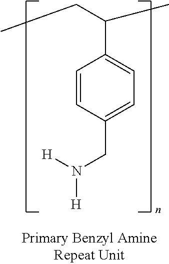

The weak-base anion resin had a matrix comprising macroporous polystyrene crosslinked with divinylbenzene and having primary amine functional groups. The weak-base anion resin was in the form of beads having an average diameter of 500 μm±50 μm.

The weak-base anion resin was loaded with copper ions by passing 1000 mg/L of copper chloride solution at pH of about 4 through the weak-base anion resin beads in a column. The weak-base anion resin loaded with copper ions was subsequently rinsed with distilled (DI) water to remove residual chemicals and air dried to prepare the Example Cu Polymer Complex. The Example Cu Polymer Complex maintained the form of beads.

### Example 2

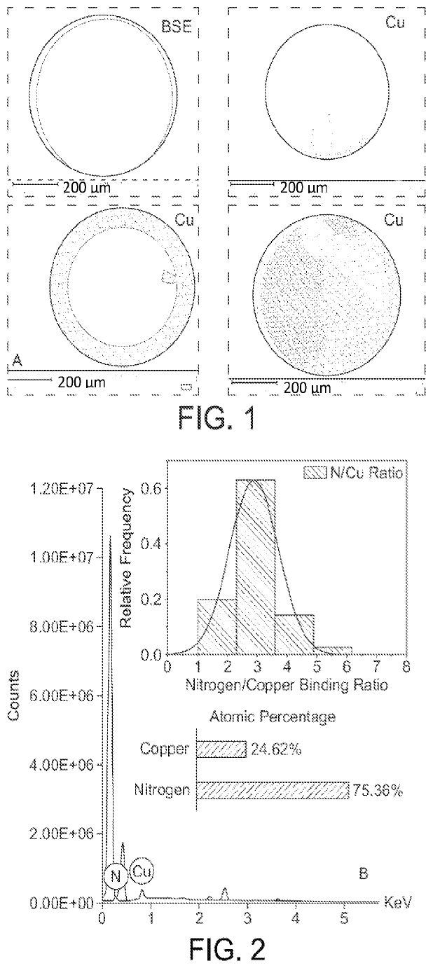

The Example Cu Polymer Complex was characterized by Scanning Electron Microscopy with Energy Dispersive X-ray (SEM-EDX). Specifically, slices of the Example Cu Polymer Complex beads were prepared using microtomy and analyzed by SEM-EDX spectroscopy to monitor the binding of the Cu(II) ion to the nitrogen donor atoms of the amine groups of the polymer. FIG. 1 is an image showing that a gradual, but distinct change in blue color occurred from the periphery to the center of the Example Cu Polymer Complex bead as an individual Example Cu Polymer Complex bead was gradually loaded with CuCl₂. FIG. 2 is an image of an EDX mapping of nitrogen (N) and copper (Cu) distribution, particularly with respect to their atomic intensities, for an Example Cu Polymer Complex bead, which is fully loaded with copper.

The binding ratio and the percentage of atomic intensity data seen in FIG. 2 indicates that one copper ion or Cu²⁺ is coordinated approximately with three nitrogen donor atoms. The nitrogen to copper ratio of approximately 3:1 for the Example Cu Polymer Complex was also separately validated using acid titration and copper loading data. One gram of fresh air-dried weak-base anion resin showed 7.55 millimoles acid neutralizing capacity corresponding to 7.55 mM of N per gram. Copper loading capacity of the same weak-base anion resin was recorded to be 175 mg or 2.75 mM. Thus, the nitrogen to copper ratio was 7.55/2.75 or 2.75; i.e., the nitrogen to copper ratio was close to approximately 3.0, as observed in the EDX of FIG. 2.

### Example 3

A non-limiting system (Example System) was prepared using the Example Cu Polymer Complexes from Examples 1 and 2 in accordance with aspects of the invention. A column having a diameter of 25 mm was filled with Example Cu Polymer Complexes. The column was coupled to an inlet stream of ambient air containing about 400 ppm (v/v) of carbon dioxide and having a relative humidity of 50%. During operation, the inlet stream had a speed so as to contact the Example Cu Polymer Complexes with an empty bed contact time (EBCT) of 1 second. Outlet air was continuously monitored for CO₂ and released into the atmosphere.

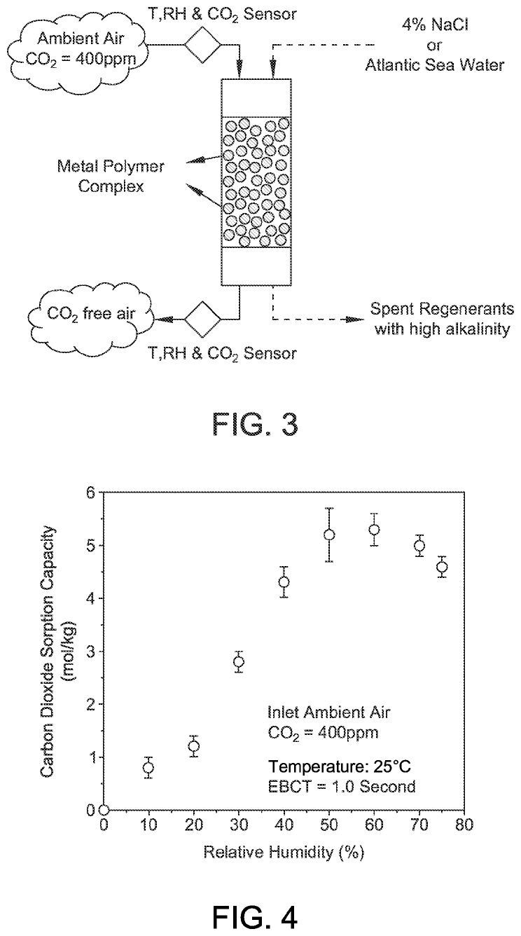

After complete CO₂ breakthrough, indicating that the sorption of CO₂ for the Example Cu Polymer Complex had reached capacity, the bed of Example Cu Polymer Complex beads was regenerated with 4% NaCl to convert all the CO₂ captured into alkalinity. If CO₂ is to be recovered as pure gaseous CO₂, the spent regenerant can be passed over a weak-acid cation exchange column to release the CO₂ from the carbonate and/or bicarbonate. FIG. 3 shows the flow diagram of the Example System.

### Example 4

The Example System of Example 3 was operated using an Example Cu Polymer Complex with inlet gases having different relative humidity. As seen in FIG. 4, the CO₂ capacity of the Example Cu Polymer Complex increased as relative humidity increased up to about 60%, and exhibited a CO₂ capacity of above 4 mol/kg at a relative humidity of about 40% to about 80%.

### Example 5

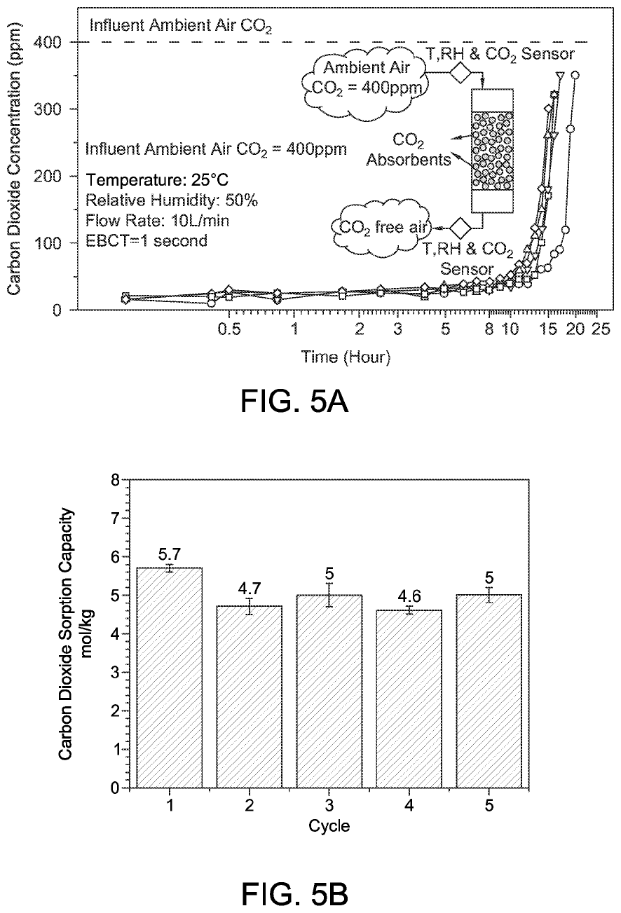

The Example System of Example 3 was operated for five consecutive runs using the bed of Example Cu Polymer Complex beads. Following every run, the bed of Example Cu Polymer Complex beads was regenerated with a salt solution having 4 wt. % NaCl with the remainder being water. FIG. 5A is a graph showing CO₂ effluent histories during five consecutive runs through the Example System. For the five consecutive runs, CO₂ breakthrough curves were nearly identical, which validates that the bed of Example Cu Polymer Complex beads can be efficiently regenerated and reused without notable loss in CO₂ capture capacity (see FIG. 5B).

### Example 6

The Example System of Example 3 was operated for a run using a bed of Example Cu Polymer Complex beads and separately for a run using a bed of weak-base anion resin beads from Example 1, which was not loaded with the copper. The Example System was operated until the complete CO₂ breakthrough, indicating that CO₂ sorption capacity had been reached.

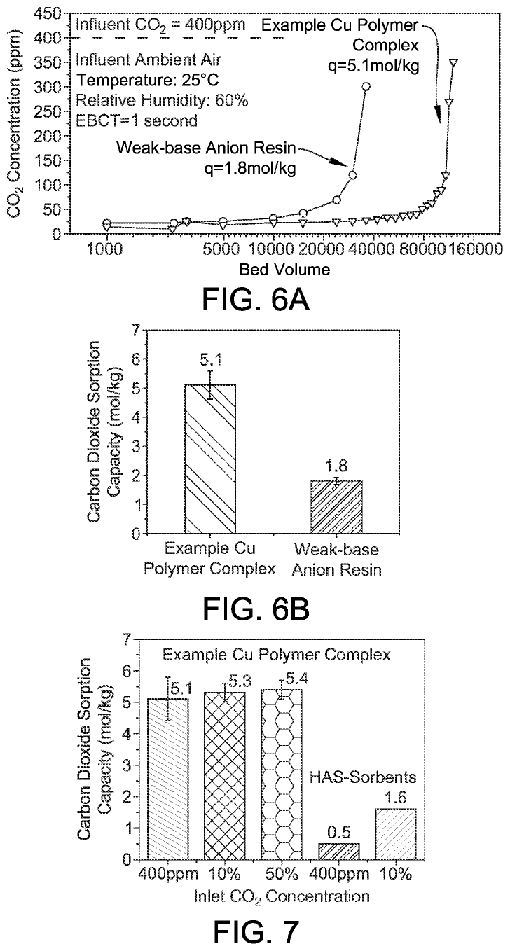

The run length using the bed of Example Cu Polymer Complex beads was significantly longer, which indicates that Example Cu Polymer Complex bed exhibited greater CO₂ removal capacity than the weak-base anion resin bed. FIG. 6A is a graph showing the CO₂ concentration during the operation of the Example System using either the Example Cu Polymer Complex bed or the weak-base anion resin bed. FIG. 6B is a bar graph showing the comparison of the average CO₂ capture capacity for the Example Cu Polymer Complex bed and the weak-base anion resin bed.

### Example 7

The Example System of Example 3 was operated with Example Cu Polymer Complex or hyperbranched amino silica (HAS) sorbents using an inlet gases having various concentrations of CO₂. Specifically, the Example System was operated using an inlet gas having 0.04 vol. % (400 ppm), 10 vol. %, or 50 vol. % of CO₂, with the remainder of the gas being nitrogen. FIG. 7 is a bar graph showing the CO₂ removal capacities when the inlet gas had 0.04 vol. %, 10 vol. %, or 50 vol. % of CO₂. It is noteworthy that the CO₂ removal capacities of the Example Cu Polymer Complex remained substantially unchanged at the various CO₂ concentrations. The CO₂ capture capacity of the Example Cu Polymer Complex is nearly independent of CO₂ concentration in the inlet gas, with all other conditions being the same. Although the CO₂ capture capacity of the hyperbranched amino silica (HAS) sorbents increased with the CO₂ concentration in the inlet gas, the CO₂ capture capacity of the HAS-sorbents was significantly less than the CO₂ capture capacity of the Example Cu Polymer Complex.

### Example 8

Beds of Example Cu Polymer Complex from Examples 1-3 were regenerated with a salt solution containing 4 wt. % NaCl with the remainder of the solution being water or with seawater, which was obtained from the Atlantic Ocean. Specifically, Example Cu Polymer Complex beds saturated with carbonate was regenerated with either the above salt solution or seawater to elute the carbonate from the bed as alkalinity and pH of the spent regenerant (namely, the salt water solution or seawater) was increased due to the hydrolysis of carbonate. The seawater was collected from the Atlantic Ocean in New Jersey (specifically at location: 39°15′58.3″N, 74°35′09.7″W) and had the following solutes and properties: Cl⁻=18,000 mg/L, Na⁺=9,000 mg/l, Ca²+=650 mg/L, alkalinity=120 mg/L as CaCO₃, and a pH=7.8.

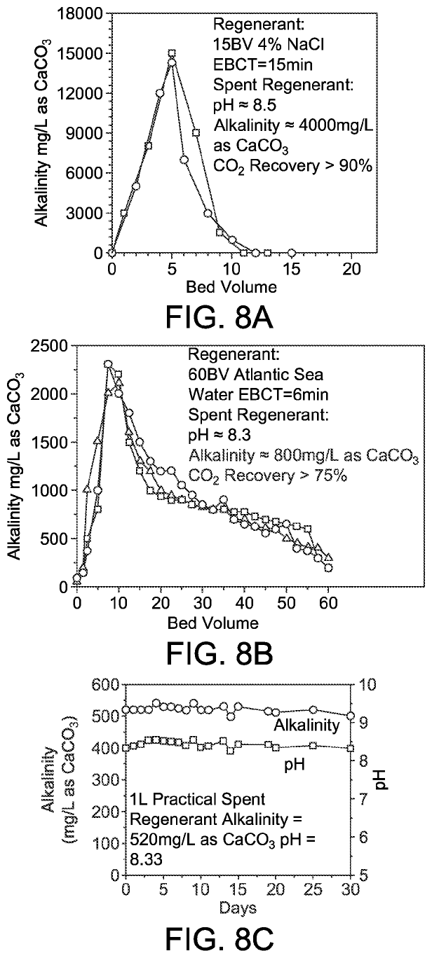

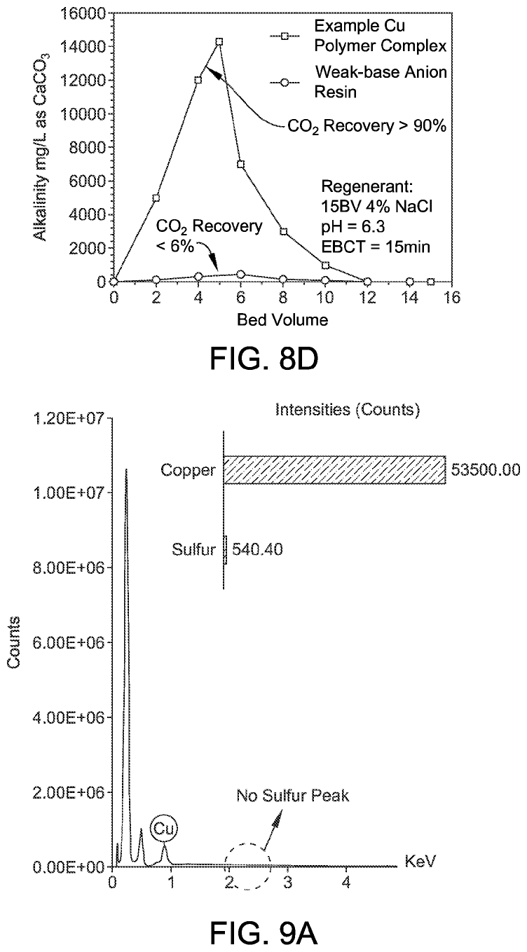

FIG. 8A is a graph showing the results of carbonate elution with over 90% recovery in ten bed volumes of regeneration with the salt solution containing 4 wt. % of NaCl. FIG. 8B shows that the saturated Example Cu Polymer Complex beds can also effectively be regenerated with seawater collected from the Atlantic Ocean. Spent regenerant can be safely returned to the ocean without any adverse impact. The salinity of the seawater does not effectively change following regeneration.

The spent regenerants, namely the seawater containing the eluted carbonate and the salt solution containing the eluted carbonate, were monitored for a month. In particular, upon exposure to open-air conditions for a month's time, the alkalinity and pH of the spent regenerants remained practically unchanged (see FIG. 8C), demonstrating the opportunity for long-term over ground sequestration of the captured CO₂ in oceans without requiring geological storage.

Additionally, for comparison purposes, a bed of weak-base anion resin beads from Example 1 was regenerated with a salt solution similar to the beds of Example Cu Polymer Complex beads, with the spent salt solution regenerant also being monitored for a month. A comparison of the regeneration using the salt solution for eluting the carbonates is presented in FIG. 8D. While 90% of CO₂ captured by the bed of Example Cu Polymer Complex beads was eluted, CO₂ recovery from the bed of weak-base anion resin beads was quite negligible (<6%). Thus, it is believed that amine-based CO₂ sorbents, such as the weak-base anion resin beads, cannot efficiently be regenerated using seawater.

### Example 9

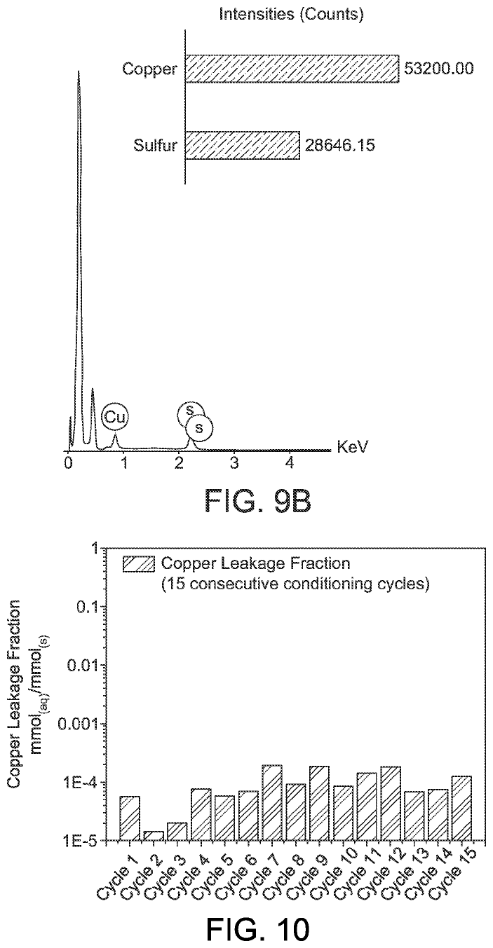

The copper stability of the Example Cu Polymer Complex was evaluated after the beds of Example Cu Polymer Complex beads were operated and regenerated with either the salt solution or the seawater discussed in Example 8 for five runs. After regeneration with the salt solution or seawater, the copper content of the Example Cu Polymer Complex beads did not undergo any noticeable change. FIGS. 9A and 9B provide a comparison of the amount of copper for fresh Example Cu Polymer Complex beads and for Example Cu Polymer Complex beads after five cycles following regeneration with Na₂SO₄, respectively. Copper concentration was measured in the exiting solution during the regeneration process and the fraction (F) of the mass of copper in the regenerant compared to the mass in the bed was plotted in FIG. 10. Notably, the loss of copper was consistently less than 0.001% of Cu in the beds of Example Cu Polymer Complex.

### Example 10

A polymer complex (Example Ni Polymer Complex) was prepared by loading the weak-base anion resin beads of Example 1 with Ni(II) by passing 1000 mg/L of nickel chloride solution through the weak-base anion resin beads according to a similar procedure as described in Example 1. The CO₂ capture capacity of the Example Ni Polymer Complex was determined by passing ambient air through a bed of Example Ni Polymer Complex beads using the Example System from Example 3.

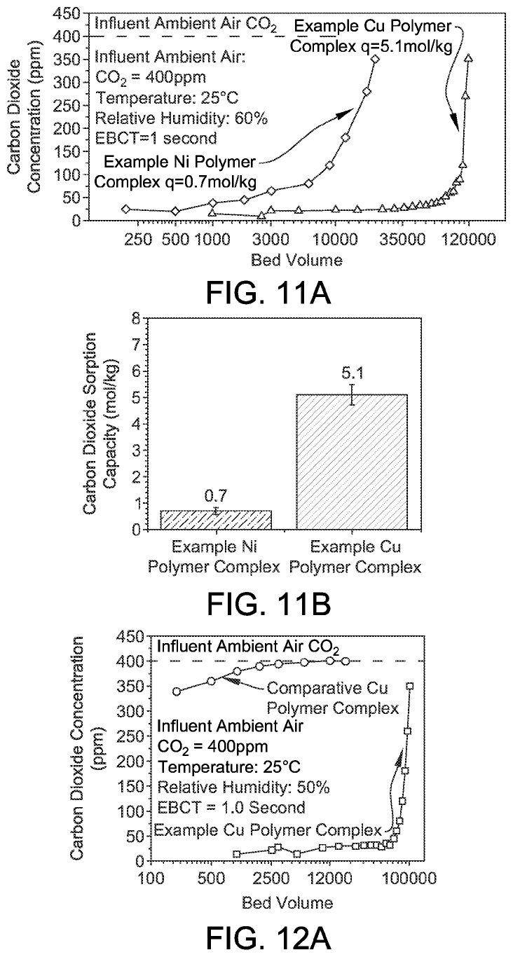

FIG. 11A shows the CO₂ effluent histories of a bed of Example Ni Polymer Complex beads and a bed of Example Cu Polymer Complex beds. FIG. 11B shows the respective CO₂ removal capacities for the Example Ni Polymer Complex bed and the Example Cu Polymer Complex bed.

### Example 11

A comparative polymer complex (Comparative Cu Polymer Complex) was prepared by loading a chelating exchanger resin comprising macroporous polystyrene crosslinked with divinylbenzene and having iminodiacetate functional groups. The general structure of the polymer of the chelating exchanger resin is shown below.

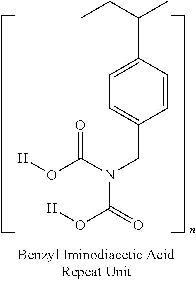

The chelating exchanger resin was then loaded with copper using a procedure similar to that described in Example 1 for the Example Cu Polymer Complex.

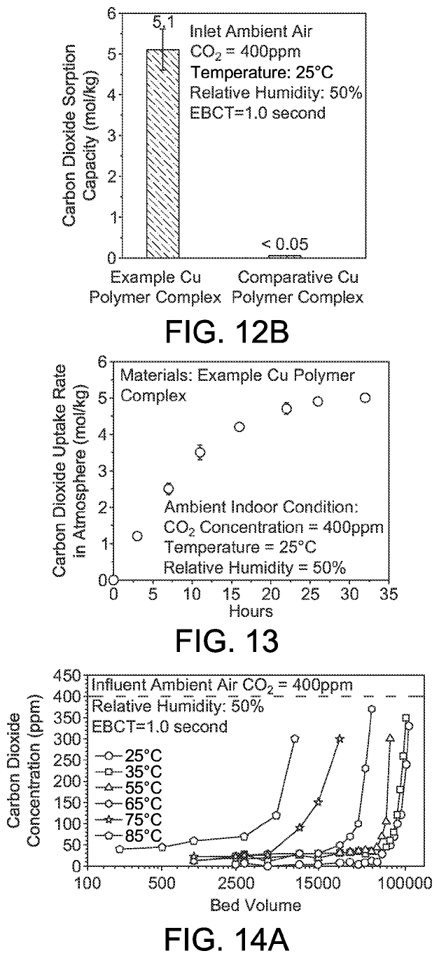

The CO₂ capture capacities of a bed of Example Cu Polymer Complex beads and a bed of Comparative Cu Polymer Complex beads were evaluated using the Example System from Example 3 with an inlet gas of atmospheric air. Experimental data shown in FIGS. 12A and 12B illustrate that the CO₂ sorption capacity of the Comparative Cu Polymer Complex beads is insignificant (less than 0.05 mole/kg) and the run length to reach the CO₂ sorption capacity of the Comparative Cu Polymer Complex using atmospheric air was short.

### Example 12

To further assess the effectiveness of the Example Cu Polymer Complex beads to capture CO₂ from atmosphere under non-flow condition, the Example Cu Polymer Complex beads were put in a petri dish and kept in the lab. Every four hours, a portion of the Example Cu Polymer Complex beads was collected, and CO₂ capture capacity was determined. FIG. 13 shows a consistent increase in carbon dioxide uptake by the Example Cu Polymer Complex beads with time under non-flow conditions. Within 20 hours, 80% of the saturation capacity for the Example Cu Polymer Complex beads was reached.

### Example 13

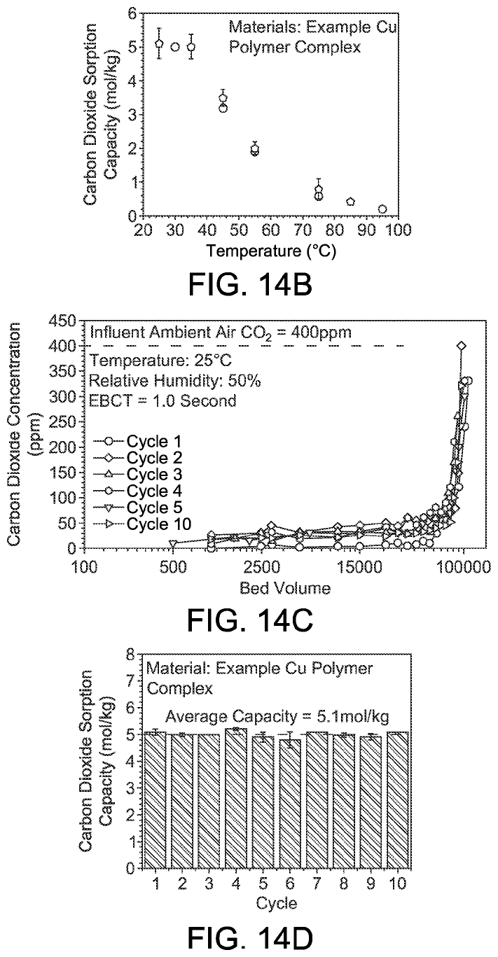

The sorption of CO₂ onto the Example Cu Polymer Complex was further characterized. Without being limited to any specific theory, the sorption of CO₂ onto the Example Cu Polymer Complex beds was determined to be an exothermic reaction as observed by a decline in CO₂ breakthrough time (see FIG. 14A) and sorption capacities (see FIG. 14B) as the temperature increases from 20 to 90° C. In order to validate the reproducibility of CO₂ uptake and the efficiency of thermal desorption, ten consecutive CO₂ uptake cycles from the atmosphere were carried out (see FIG. 14C), followed by thermal desorption with tap water at a temperature of 80° C. The experimentally determined CO₂ uptake capacities of the ten consecutive cycles were nearly the same (see FIG. 14D), confirming the effectiveness of thermal regeneration.

1-42. (canceled)

43. A metal polymer complex comprising a polymer comprising at least one monomer having an amine group, the polymer complexed with a transition metal selected from nickel, zinc, copper, and a combination of two or more thereof.

44. The metal polymer complex according to claim 43, wherein the polymer is a vinyl polymer comprising a phenyl group substituted with the amine group.

45. The metal polymer complex according to claim 44, wherein the phenyl group is para substituted with the amine group.

46. The metal polymer complex according to claim 43, wherein the transition metal is selected from nickel, copper, and a combination of two or more thereof.

47. The metal polymer complex according to claim 46, wherein the metal polymer complex comprises copper; and wherein the metal polymer complex has a nitrogen to copper ratio of about 2.5 to about 3.5.

48. The metal polymer complex according to claim 47, wherein the metal polymer complex has positive charge of 2 or more.

49. The metal polymer complex according to claim 43, wherein the metal polymer complex is substantially free of or free of silica and/or silicate.

50. The metal polymer complex according to claim 43, wherein the metal polymer complex is substantially free of or free of zinc.

51. The metal polymer complex according to claim 43, wherein the metal polymer complex comprises an anionic exchange resin

52. The metal polymer complex according to claim 51, wherein the anionic exchange resin is formed at least partially from the polymer.

53. A method for capturing carbon dioxide, the method comprising:
providing an inlet gas comprising carbon dioxide and water;
producing a carbonate, a bicarbonate, a salt thereof, or a combination thereof to remove carbon dioxide from the inlet gas by contacting the inlet gas with a polymer complex substrate; and
removing the carbonate, the bicarbonate, the salt thereof, or the combination thereof from the polymer complex substrate by contacting the polymer complex substrate with a regenerant solution comprising water and at least one of a salt or an acid.

54. The method according to claim 53, wherein the polymer complex substrate comprises a metal polymer complex.

55. The method according to claim 53, wherein the metal polymer complex comprises a polymer comprising at least one monomer having a primary amine group, wherein the polymer is complexed with a copper ion, a nickel ion, or a combination thereof.

56. The method according to claim 53, wherein the gas stream has a relative humidity of about 20% or more at a temperature of 25° C.

57. The method according to claim 53, wherein the inlet gas has a temperature of 42° C. or less.

58. The method according to claim 53, wherein the regenerant solution comprises an acid selected from strong Lewis acids.

59. The method according to claim 53, wherein the regenerant solution comprises an acid selected from hydrochloric acid, nitric acid, sulfuric acid, hydrobromic acid, perchloric acid, and a combination of two or more thereof.

60. The method according to claim 53, wherein the regenerant solution further comprises a salt selected from: sodium chloride, sodium nitrate, sodium sulfate, sodium lactate, potassium chloride, potassium sulfate, potassium nitrate, potassium lactate, and a combination of two or more thereof.

61. The method according to claim 53, wherein the carbonate, the bicarbonate, the salt thereof, or the combination thereof is removed from the polymer complex substrate using the regenerant solution without the addition of external heat.

62. The method according to claim 53, further comprising recovering CO₂ from the regenerant solution by contacting the regenerant solution with a weak-acid cation exchanger selected from polyacrylic macroporous/porous weak-acid cation exchangers having carboxylic acid functional groups, polymethacrylic macroporous/porous weak-acid cation exchangers having carboxylic acid functional groups, shallow shell polyacrylic macroporous/porous weak-acid cation exchangers in hydrogen form having carboxylic acid functional groups, and combinations of two or more thereof.
